(19) United States
(12) Patent Application Publication
(10) Pub. No.: US 2009/0086135 A1
(43) Pub. Date: Apr. 2, 2009

(54) Liquid Crystal Display Device

(75) Inventor: Yuji Maede, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/237,459

(22) Filed: Sep. 25, 2008

(30) Foreign Application Priority Data
Sep. 27, 2007 (JP) 2007-250664

(51) Int. Cl. G02F 1/1335

(52) U.S. Cl. 349/110

(57) ABSTRACT

(Object) To provide a liquid crystal display device where the aperture ratio of pixels is higher.
(Means for Achieving Object) A liquid crystal display device is provided with a first substrate, a second substrate and a liquid crystal layer sandwiched between the above described first substrate and the above described second substrate, and
the above described first substrate has a number of gate signal lines, drain signal lines which cross the above described number of gate signal lines, and a number of pixels arranged in a matrix,
each of the above described number of pixels has a thin film transistor, a pixel electrode and a counter electrode,
the above described light transmitting counter electrodes, a first insulating film, a second insulating film and the above described light transmitting pixel electrodes are formed on the above described first substrate in this order, so that an electrical field generated as a result of a difference in potential between the above described pixel electrodes and the above described counter electrodes can control the above described liquid crystal layer,
the above described thin film transistor has a gate electrode formed of part of the above described gate signal line, a drain electrode formed of part of the above described drain signal line, and a source electrode connected to the above described pixel electrode through a through hole created in the above described second insulating film,
the above described counter electrode has a pattern in plane form,
the above described pixel electrode is formed so as to have a number of linear electrodes which overlap with the above described counter electrode in a pattern, and
the above described source electrode is formed of a light blocking material, located between the above described first insulating film and the above described second insulating film, and formed so as to extend in the direction in which the above described gate signal lines run and overlap with 80% or more of the total length in one end portion of the above described pixel electrode on the above described gate signal line side.

The present application claims priority over Japanese Application JP 2007-250664 filed on Sep. 27, 2007, the contents of which are hereby incorporated into this application by reference.

### BACKGROUND OF THE INVENTION

(1) Field of the Invention

The present invention relates to a liquid crystal display device and, in particular, to an active matrix type liquid crystal display device where each pixel on one substrate has a light transmitting counter electrode, an insulating film and a light transmitting pixel electrode having an electrode group made up of a number of linear electrodes which overlap with the above described counter electrode in this order from the substrate.

(2) Related Art Statement

These types of liquid crystal display devices are referred to as so-called IPS (in-plane-switching) types, where liquid crystal can be controlled using an electrical field having a component parallel to the substrate between pixel electrodes and counter electrodes, and known to have excellent wide view angle properties.

In addition, in active matrix type liquid crystal display devices, each pixel in the matrix is provided with a thin film transistor, and this thin film transistors functions as a switching element for selecting a pixel.

That is to say, gate electrodes of thin film transistors for respective pixels aligned in rows are connected through a common gate signal line, and the pixel electrodes for respective pixels aligned in columns are connected to a drain signal line shared by the respective pixels via the thin film transistors in the configuration.

When a signal (scanning signal) is supplied to a gate signal line, pixels in the corresponding row are selected by turning on the thin film transistors for these pixels, so that a video signal is supplied to the pixel electrodes of the above described respective pixels through the respective drain signal lines.

Patent Document 1 described below, for example, discloses a liquid crystal display device having the above configuration.

(Patent Document 1) Japanese Unexamined Patent Publication 2005-300821 (Corresponding U.S. Application US2005/0225708 A1)

### SUMMARY OF THE INVENTION

### Problem to be Solved by the Invention

In liquid crystal display devices having the above configuration, further increase in the aperture ratio of the pixels is desired, and it has been sought to achieve this together with the increase in size of liquid crystal devices.

The present inventors succeeded in increasing the aperture ratio of pixels on the basis of the following.

That is to say, in the case where a gate signal (voltage) is supplied to a gate signal line so that the corresponding thin film transistor is turned on in liquid crystal display devices having the above described configuration, a video signal of a drain signal line is applied to a pixel electrode PX via the thin film transistor that is turned on, so that there is a difference in potential between the pixel electrode and the above described gate signal line, and an electrical field is generated in accordance with this difference in potential.

This electrical field is an electrical field having different noise components from the electrical field generated between pixel electrodes and counter electrodes, and usually light is blocked by a black matrix (light blocking film), for example, in the portion where the electrical field is generated, so that the change in the light transmittance of liquid crystal caused by the electrical field is not visible to the eye.

The electrical field (rotating electrical field) is generated between pixel electrodes and gate signal lines, so that the electric lines of force greatly bulge out to the liquid crystal side, and the area where light must be blocked becomes larger in accordance with the degree of bulging.

This means that if the electric lines of force of the electrical field generated between pixel electrodes and gate signal lines can be prevented from bulging out to the liquid crystal side, the area where light must be blocked can be made smaller in accordance with the degree to which bulging is prevented, and thus, the aperture ratio of pixels can be increased.

An object of the present invention is to provide a liquid crystal display device where the aperture ratio is higher.

### Means for Solving Problem

The gist of typical inventions from among the inventions disclosed in the present application is briefly described below.

(1) The liquid crystal display device according to the present invention is provided with a first substrate, a second substrate and a liquid crystal layer sandwiched between the above described first substrate and the above described second substrate, and characterized in that

the above described first substrate has a number of gate signal lines, drain signal lines which cross the above described number of gate signal lines, and a number of pixels arranged in a matrix,

each of the above described number of pixels has a thin film transistor, a pixel electrode and a counter electrode,

the above described light transmitting counter electrodes, a first insulating film, a second insulating film and the above described light transmitting pixel electrodes are formed on the above described first substrate in this order, so that an electrical field generated as a result of a difference in potential between the above described pixel electrodes and the above described counter electrodes can control the above described liquid crystal layer,

the above described thin film transistor has a gate electrode formed of part of the above described gate signal line, a drain electrode formed of part of the above described drain signal line, and a source electrode connected to the above described pixel electrode through a through hole created in the above described second insulating film,

the above described counter electrode has a pattern in plane form,

the above described pixel electrode is formed so as to have a number of linear electrodes which overlap with the above described counter electrode in a pattern, and

the above described source electrode is formed of a light blocking material, located between the above described first insulating film and the above described second insulating film, and formed so as to extend in the direction in which the above described gate signal lines run and overlap with 80% or more of the total length in one end portion of the above described pixel electrode on the above described gate signal line side.

(2) The liquid crystal display device according to the present invention has the same configuration as (1), and is characterized in that part of the above described source electrode forms an electrical field controlling electrode for reducing the rotating electrical field generated between the above described gate signal lines and the above described pixel electrodes, for example.

(3) The liquid crystal display device according to the present invention has the same configuration as (2), and is characterized in that part of the above described electrical field controlling electrode in the direction in which the above described electrical field controlling electrode extends includes a pad portion of the above described source electrode for achieving electrical connection with the above described pixel electrode, for example.

Here, the present invention is not limited to the above described configuration, and various modifications are possible, as long as the technological idea of the present invention is not deviated from.

### EFFECTS OF THE INVENTION

In the thus formed liquid crystal display device, the aperture ratio is higher.

### BRIEF DESCRIPTION OF THE DRAWINGS

FIGS. 1A and 1B are a diagram showing the configuration of the main portion of a pixel in the liquid crystal display device according to one embodiment of the present invention;

FIG. 2 is a diagram showing the configuration of the entirety of the liquid crystal display device according to one embodiment of the present invention;

FIG. 3 is a diagram showing the configuration of the entirety of a pixel in the liquid crystal display device according to one embodiment of the present invention;

FIG. 4 is a cross sectional diagram along line IV-IV in FIG. 3;

FIGS. 5A and 5B are a diagram showing an example of the configuration of the main portion of a conventional liquid crystal display device, and corresponds to FIGS. 1A and 1B; and

FIGS. 6A and 6B are a diagram illustrating the effects of the liquid crystal display device according to the present invention.

### EXPLANATION OF SYMBOLS

SUB1, SUB2 . . . substrates
SL . . . sealing material
AR . . . liquid crystal display region
SCN(V) . . . semiconductor device (scanning signal drive circuit)
SCN(He) . . . semiconductor device (video signal drive circuit)
GL . . . gate signal line
DL . . . drain signal line
CL . . . counter voltage signal line
TFT . . . thin film transistor
DT . . . drain electrode
ST . . . source electrode
PD . . . pad portion
PX . . . pixel electrode
CT . . . counter electrode
EFC . . . electrical field controlling electrode
GI . . . insulating film
PAS . . . passivation film
ORI1 . . . orientation film
BM . . . black matrix
FIL . . . color filter

### DETAILED DESCRIPTION OF THE INVENTION

### Best Mode for Carrying Out the Invention

In the following, the liquid crystal display device according to one embodiment of the present invention is described in reference to the drawings.

### <Configuration of Entirety>

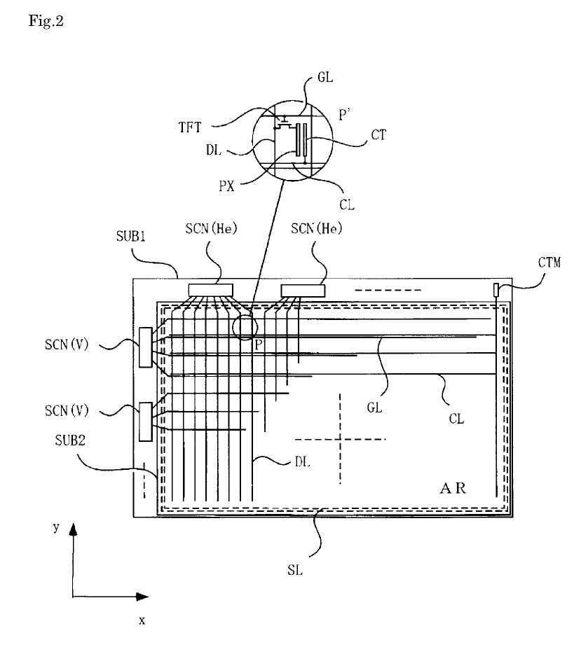

FIG. 2 is a diagram showing the configuration of the entirety of the liquid crystal display device according to one embodiment of the present invention.

In FIG. 2, the liquid crystal display device has a pair of parallel substrates SUB1 and SUB2 made of glass, for example, as outer walls, and liquid crystal (not shown) is sandwiched between the substrates SUB1 and SUB2.

The liquid crystal is sealed in using a sealing material SL which also secures the substrate SUB2 to the substrate SUB1, and the region surrounded by the sealing material SL forms a liquid crystal display region AR.

The substrate SUB1 is formed so as to have a larger area than the substrate SUB2, for example, and has regions which are exposed from under the above described substrate SUB2 in the left side portion and the upper side portion in the figure.

A number of semiconductor devices SCN(V) are mounted side-by-side in the above described region in the left side portion of the substrate SUB1, and a number of semiconductor devices SCN(He) are mounted side-by-side in the above described region in the upper side portion of the substrate SUB1. The above described number of semiconductor devices SCN(V) form a scanning signal drive circuit and are connected to the gate signal lines GL described below, and the above described number of semiconductor devices SCN(He) form a video signal drive circuit and are connected to the drain signal lines DL described below.

The gate signal lines GL, which extend in the direction x in the figure and are aligned in the direction y, as well as the drain signal lines DL, which extend in the direction y in the figure and are aligned in the direction x, are formed within a liquid crystal display region AR on the surface of the substrate SUB1 on the liquid crystal side.

Rectangular regions surrounded by adjacent gate signal lines GL and adjacent drain signal lines DL form pixel regions, and as a result, the pixels are arranged in a matrix within the liquid crystal display region AR.

The end portion on the left side of the respective gate signal lines GL described above extends over the sealing material SL and outward from the liquid crystal display region AR, and is connected to the output terminals of the closest of the above described semiconductor devices SCN(V), so that the semiconductor devices SCN(V) can supply a scanning signal (voltage).

The end portion on the top side of the respective drain signal lines DL described above extends over the sealing material SL and outward from the liquid crystal display region AR, and is connected to the output terminals of the closest of the above described semiconductor devices SCN(He), so that the semiconductor devices SCN(He) can supply a video signal (voltage).

As shown in the circle P′, which is an enlargement of the circle P in the figure, the above described pixels are provided with a thin film transistor TFT which is turned on by a scanning signal from the gate signal line GL, a pixel electrode PX to which a video signal is supplied from the drain signal line DL via the turned-on thin film transistor TFT, and a counter electrode CT for generating an electrical field as a result of the difference in potential between the counter electrode CT and the above described pixel electrode PX to which a reference voltage is applied. The pixel electrode PX and the counter electrode CT are both formed on the same substrate SUB1, and the above described electrical field includes an electrical field component which is parallel to the surface of the substrate SUB1, and thus, display devices where molecules of liquid crystal are controlled by an electrical field are referred to as lateral electrical field types.

Here, the reference voltage is applied to the above described counter electrode CT through a counter voltage signal line CL which is parallel to the gate signal line GL, for example, and the counter voltage signal line CL extends over the above described sealing material SL and is connected to a counter voltage terminal CTM formed on the surface of the substrate SUB1.

In the above described embodiment, the scanning signal drive circuit V and video signal drive circuit He are mounted on the substrate SUB1 in the configuration. However, the invention is not limited to this, and semiconductor devices formed using a so-called tape carrier method (semiconductor devices where semiconductor chips are mounted on a flexible substrate) may be provided so as to cross the above described substrate SUB1 and a printed circuit board, not shown, in the configuration.

### <Configuration of Pixels>

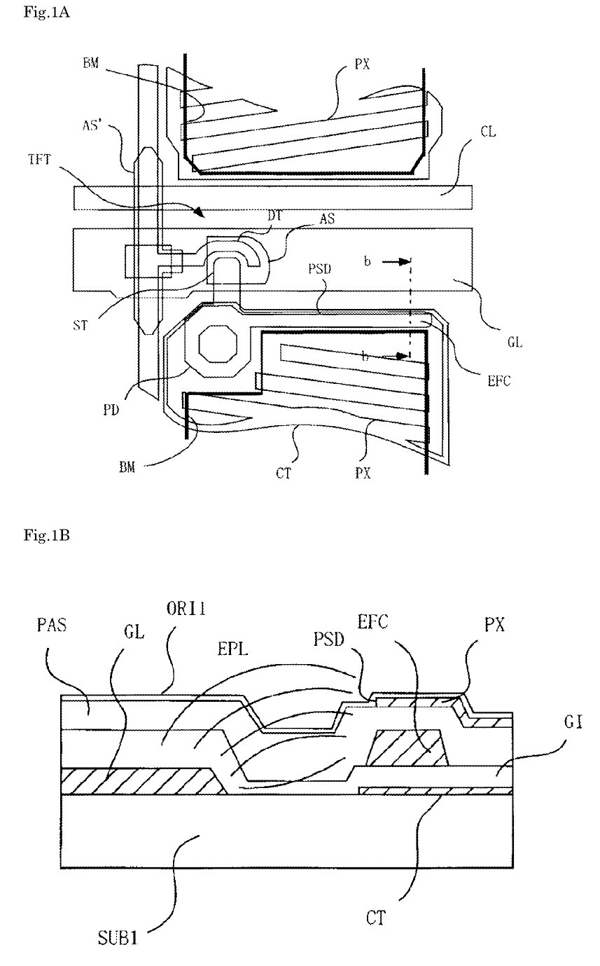

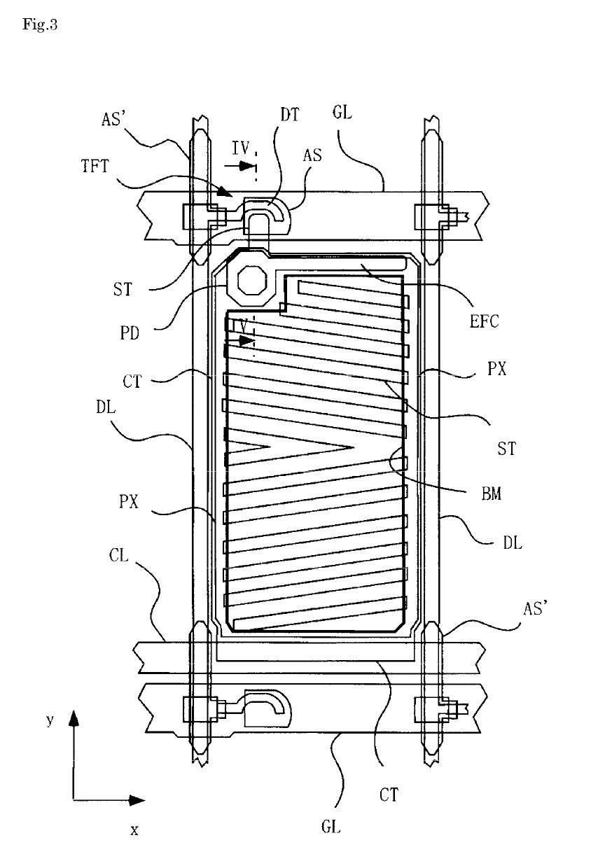

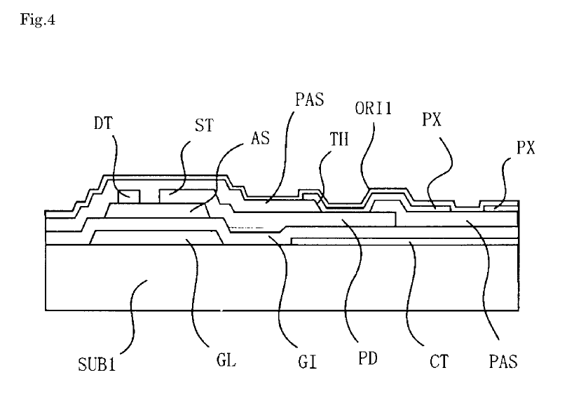

FIG. 3 is a plan diagram showing an example of one pixel from among the pixels arranged in a matrix in the above described liquid crystal display panel PNL on the substrate SUB1 side. The respective pixels arranged on the top, bottom, left and right of the pixel shown in FIGS. 1A and 1B have the same configuration as the pixel in this figure. In addition, FIG. 4 is a cross sectional diagram along line IV-IV in FIG. 3.

First, gate signal lines GL and counter voltage lines CL are formed in parallel over a relatively large distance on the surface of the substrate SUB1 on the liquid crystal side.

Counter electrodes CT are formed of a transparent conductive material, for example ITO (indium tin oxide) in regions between gate signal lines GL and counter voltage signal lines CL. The counter electrodes CT are formed so as to overlap with the counter voltage signal lines CL in the side portions on the counter voltage signal line CL side, and as a result, electrically connected to the counter voltage signal lines CL. The counter electrodes CT have such a pattern in a plane as to occupy 80% or more of the total area of the pixels.

In addition, an insulating film GI (see FIG. 4) is formed so as to have the above described signal lines GL, counter voltage signal lines CL and counter electrodes CT on the surface of the substrate SUB1. This insulating film GI functions as a gate insulating film for the thin film transistors TFT in the below described regions where a thin film transistor TFT is formed, and the film thickness is set accordingly.

An amorphous semiconductor layer AS is formed of amorphous silicon, for example, in a portion on the top surface of the above described insulating film GI where the above described gate signals lines GL partially overlap. This semiconductor layer AS becomes s semiconductor layer for the above described thin film transistors TFT.

In addition, a semiconductor layer AS′ is formed at the same time as the above described semiconductor layer where the gate signal lines GL and the counter voltage signal lines CL intersect with the below described drain signal lines DL. This semiconductor layer AS′ functions as an interlayer insulating film between the gate electrodes GL, the counter voltage signal lines CL and the above described drain signal lines DL, together with the above described insulating film GI.

In addition, the drain signal lines DL are formed so as to extend in the direction y in the figure, and the drain signal lines DL extend to a region on the side where thin film transistors TFT are formed at some intersections with the gate signal lines GL, and the extending portions reach the top surface of the above described semiconductor layer AS and form the drain electrodes DT of the thin film transistors TFT.

In addition, the source electrodes ST of the above described thin film transistors TFT formed at the same time as the drain signal lines DL and the drain electrodes DT face the above described drain electrodes DT on the above described semiconductor layer AS, and extend from an area on the semiconductor layer AS to the region where the semiconductor layer AS is not formed, and thus, the extending portions reach the pixel region side and form pad portions PD. Here, the pad portions PD form part of the source electrodes ST. These pad portions PD are electrically and physically connected to the below described pixel electrodes PX, and formed so as to have an area with a greater width than the portion which overlaps with the semiconductor layer AS that is part of the above described source electrodes ST.

In this embodiment, the above described pad portions PD are provided with an electrical field controlling electrode EFC which is integrated with the pad portion PD. That is to say, the electrical field controlling electrode EFC also forms part of the source electrode ST. This electrical field controlling electrode EFC is in proximity to the above described gate signal line GL, and formed so as to extend from the above described pad portion PD parallel to the gate signal line GL. The configuration and function of this electrical field controlling electrode EFC are described below.

The above described drain electrodes DT are formed in an arc pattern and surround the end portion of the above described source electrodes ST, for example, and thus, the width of the channel of the thin film transistors TFT is great in the configuration.

Here, when the above described semiconductor layer AS is formed on the insulating film GI, the surface is doped with an impurity of a high concentration, and the above described drain electrodes DT and source electrodes ST are formed through patterning, for example, and after that, the impurity layer of a high concentration formed in regions other than the regions where the drain electrodes DT and source electrodes ST are formed is etched using the drain electrodes DT and the source electrodes ST as a mask. The impurity layer of a high concentration (not shown) remains between the semiconductor layer AS and the drain electrode DT, as well as between the semiconductor layer AS and the source electrodes ST, so that an ohmic contact layer is formed of this impurity layer.

Thus, the above described tin film transistors TFT are formed as MIS (metal insulator semiconductor) type transistors having a so-called reverse staggered structure, with part of a gate signal line GL used as the gate electrode.

Here, when MIS type transistors are driven, the drain electrode DT and the source electrode ST may be switched, depending on the bias applied. In the description in this specification, however, the electrode connected to a drain signal line DL is referred to as drain electrode DT, and the electrode connected to a pixel electrode PX is referred to as source electrode ST, for the sake of convenience.

A passivation film PAS (see FIG. 4) is formed of an insulating film so as to cover the above described thin film transistors TFT on the surface of the substrate SUB1. This passivation film PAS is provided in order to prevent the thin film transistors TFT from making direct contact with the liquid crystal. In addition, the passivation film PAS is provided so as to intervene between the above described counter electrodes CT and the below described pixel electrodes PX, and functions as a dielectric film for the capacitor element provided between the counter electrode CT and the pixel electrode PX, together with the above described insulating film GI.

Pixel electrodes PX are formed on the upper surface of the above described passivation film PAS. The pixel electrodes PX are formed of a transparent conductive film, for example of ITO (indium tin oxide), and the outline almost perfectly coincides with the outline of the above described counter electrodes CT.

In addition, a number of slits ST are created in the pixel electrodes PX at a slight angle relative to the direction in which the gate signal lines GL run, and aligned in such a direction as to cross the longitudinal direction of the slits. As a result, the pixel electrodes PX are formed so as to have an electrode group made of a great number of linear electrodes in band form which are connected at the two ends. Here, the number of linear electrodes may be connected at one end instead of at the two ends.

The linear electrodes of the pixel electrodes PX are formed so as to extend in the direction of the +angle relative to the direction in which the gate signal lines GL run in one region of the region of the pixels which are divided in two, for example top and bottom in the figure, and formed so as to extend in the direction of the −angle in other regions. A so-called multi-domain system is adopted, and in the case were the direction of the slits ST provided in the pixel electrode PX within each pixel (direction of electrode group in pixel electrode PX) is single, the configuration has no such disadvantage that the color tone changes depending on the view angle.

The thus formed pixel electrodes PX are electrically connected to the above described pad portions PD of the source electrodes ST in the thin film transistors TFT through the through holes TH created in the above described passivation film PAS in portions close to the thin film transistors TFT (see FIG. 4).

In addition, an orientation film ORI1 is formed on the surface of the above described substrate SUB1 so as to cover the pixel electrodes PX (see FIG. 4), and this orientation film ORI1 sets the initial direction of orientation of liquid crystal molecules which make direct contact with the orientation film ORI1.

Though in the above described embodiment, the semiconductor layers AS and AS′ use amorphous silicon, the present invention is not limited to this, and polysilicon may be used, for example.

### <Electrical Field Controlling Electrode EFC>

FIG. 1A is a diagram showing an enlargement of the above described electrical field controlling electrode EFC and the vicinity of this electrical field controlling electrode EFC in the configuration of the pixel shown in FIG. 3. FIG. 1B is a cross sectional diagram along line b-b in FIG. 1A.

In FIG. 1A, first, in a pixel region on the side beneath the gate signal line GL in the figure on the top surface of the substrate SUB1, a counter electrode CT is formed, so that the side portion on the upper side (end portion) is close and parallel to the above described gate signal line GL.

In addition, an electrical field controlling electrode EFC is formed on the top surface of the insulating film GI formed so as to cover the above described counter electrode CT so as to be close and parallel to the above described gate signal line GL (see FIG. 1B). Here, FIGS. 1A and 1B show an example where the electrical field controlling electrode EFC does not overlap with the side portion (end portion) on the upper side of the counter electrode CT. However, the invention is not limited to this, and the electrical field controlling electrode EFC may overlap in the side portion (end portion) on the upper side of the counter electrode CT.

Here, a thin film transistor TFT is formed so as to overlap with part of the above described gate signal line GL, and the source electrode ST reaches the region where the semiconductor layer AS is not formed and extends to a portion of the pixel region, and the extending portion forms a pad portion PD of a relatively large area (area larger than portion where source electrode ST overlaps with semiconductor layer AS).

The above described electrical field controlling electrode EFC is formed of the same material as the pad portion PD and integrated with the pad portion PD, as described above.

In addition, the above described electrical field controlling electrode EFC is formed so as to be integrated with the pad portion PD on the side of the above described pad portion PD close to the gate signal line GL, and thus, the above described electrical field controlling electrode EFC is located as close to the gate signal line GL as possible. As is clear from the description below, this is in order to make the substantial aperture ratio of the pixel as high as possible.

In this configuration, the above described electrical field controlling electrode EFC is formed so as to occupy most of the pixel region in the direction in which the gate signal line GL runs in the length (80% or more), together with the above described pad portion PD.

Here, as is clear from the description below, the above described pad portion PD has the same working effects and function as the electrical field controlling electrode EFC provided in the present embodiment, and therefore, in this specification, electrical field controlling electrode in some cases is meant to refer to the combination of the above described electrical field controlling electrode EFC and pad portion PD.

The source electrode (including the pad portion PD and the electrical field controlling electrode PD) is formed of a light blocking material (for example a metal film), and therefore, works as a light blocking film.

In addition, a pixel electrode PX is formed on the upper surface of the above described passivation film PAS, which is formed so as to cover the above described electrical field controlling electrode EFC, so that the side portion PSD on the upper side (end portion) is close and parallel to the above described gate signal line GL.

Here, it is desirable for the source electrode (including the pad portion PD and the electrical field controlling electrode PD) to overlap with 80% or more of one side portion (end portion) PSD of the pixel electrode PS on the gate signal line GL side.

In this configuration, in the case where the thin film transistor in the figure is turned on when a gate signal (voltage) is supplied from the gate signal line GL, a video signal of the drain signal line DL is applied to the pixel electrode PX via the thin film transistor TFT, so that an electrical field is generated in accordance with the difference in potential between the above described gate signal line GL and the pixel electrode PX. This electrical field is an electrical field made up of noise components and different from the electrical field generated between the pixel electrode PX and the counter electrode CT.

In this case, where the electrical field (rotating electrical field) is generated only between the above described gate signal line and the pixel electrode PX, the electric lines of force EPL in the figure in the electrical field bulge out greatly to the substrate SUB2 side, and the electrical field is generated between the above described gate signal line GL and the above described electrical field controlling electrode EFC, as well as between the above described gate signal line GL and pixel electrode PX, and thus, the degree to which the above described electric lines of force EPL bulge out (rotating electrical field) is greatly reduced. As a result, the intensity of light leaking from between the pixel electrode PX and the gate signal line as a result of the rotating electrical field can be lowered. In addition, it is also possible to reduce the area of the region where light leaks due to the rotating electrical field.

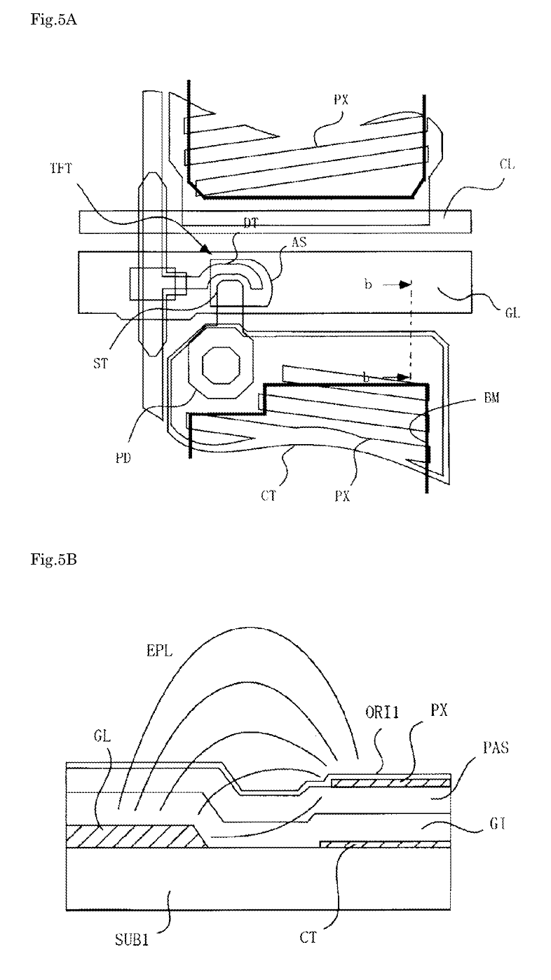

FIGS. 5A and 5B correspond to FIGS. 1A and 1B, and show a conventional configuration where no electrical field controlling electrode EFC is formed, unlike in the present embodiment. In FIG. 5B, the electrical field, which is generated only between the gate signal line GL and the pixel electrode PX, bulges out greatly to the substrate SUB2 side, which faces the electric lines of force EPL.

Meanwhile, in FIG. 1B, an electrical field is generated between the above described gate signal line GL and the above described electrical field controlling electrode EFC, as well as between the gate signal line GL and the pixel electrode PX. In the case where the difference in potential is the same, the number of electric lines of force EPL is equal, and therefore, the former electrical field suppresses bulging out of the latter electrical lines of force EPL.

As described above, in the case where bulging out of the electric lines of force EPL between the gate signal line GL and the pixel electrode PX can be suppressed by providing the electrical field controlling electrode EFC, movement of liquid crystal due to the electrical field can be limited within the region between the gate signal line GL and the side portion (end portion) PSD on the upper side of the pixel electrode PX, which is at a slight distance from the gate signal line GL, and in addition, can be prevented from affecting the center portion of the pixel electrode PX.

As described above, the area of the region which is affected by the noise electrical field can be reduced on the pixel electrode PX, and thus, the region where light should be prevented from leaking (for example the region where a black matrix (light blocking film) is formed on the substrate SUB2, which faces the substrate SUB1) becomes smaller, and therefore, the aperture ratio of the pixels can be increased.

Here, as described above, it was confirmed through experiment that sufficient effects can be gained by making the source electrode (including the pad portion PD and the electrical field controlling electrode PD) overlap with 80% or more of the entire length of one side portion (end portion) PSD of the pixel electrode PX on the gate signal line GL side.

### <Black Matrix>

The black matrix is a light blocking film formed on the surface of the substrate SUB2 on the liquid crystal side, where the substrate SUB2 faces the above described substrate SUB1 with liquid crystal in between, and defines the pixel regions from adjacent pixel regions on the top, bottom, left and right. Here, the portion of the black matrix may be omitted in the direction parallel to the drain signal lines DL (direction y).

In the pixel shown in FIGS. 1A, 1B and 3, the above described black matrix BM has an opening in the portion surrounded by thick lines, and is formed so as to cover the gate signal line GL, the counter electrode signal line CL and the drain signal line DL.

Thus, the substantial aperture ratio of the pixels is affected by the area of the opening in the above described black matrix BM.

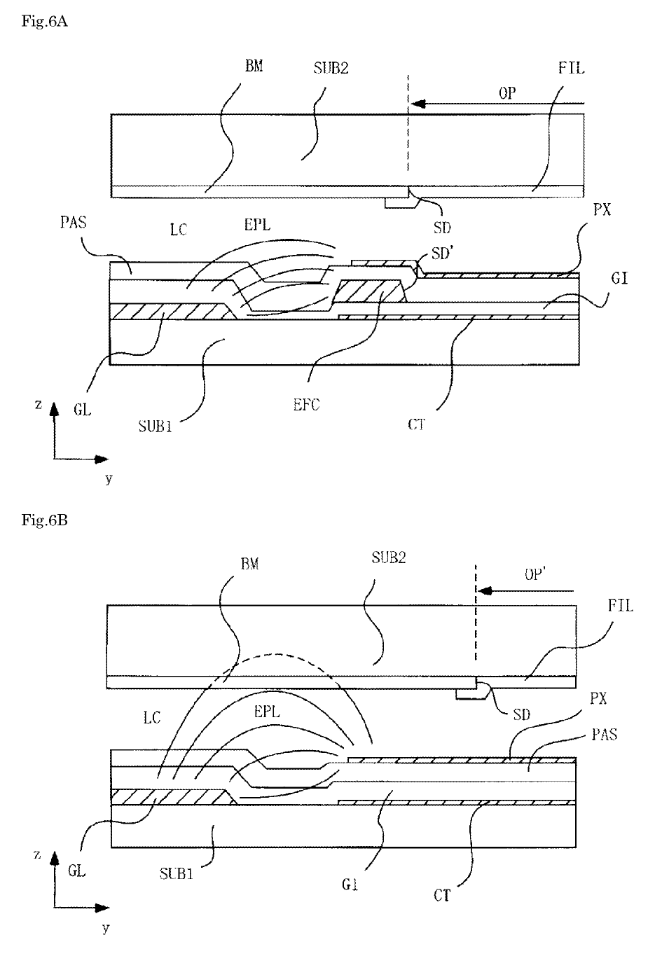

FIG. 6A is a cross sectional diagram showing the substrate SUB2 (with the black matrix BM), in addition to the components shown in FIG. 1B. In addition, for the sake of comparison, FIG. 6B is a cross sectional diagram showing the substrate SUB2 (with the black matrix BM), in addition to the components shown in FIG. 5B. Here, the orientation film, which makes contact with the liquid crystal, is not shown in FIGS. 6A and 6B.

As shown in FIG. 6A, the black matrix BM provided above the gate signal lines GL is formed so that the width becomes greater on the side where the pixel electrodes PX are formed (width in direction y in figure), and the black matrix BM is formed so as to overlap with the side portion (end portion) PSD of the pixel electrode PX on the side of the above described gate signal lines GL.

This is in order to prevent light from leaking due to the movement of liquid crystal molecules in the electrical field (rotating electrical field) generated between the gate signal line GL and the pixel electrode PX.

In this case, the above described electrical field controlling electrode EFC is formed beneath the above described side portion (end portion) PSD of the pixel electrode PX, and the width of the above described black matrix BM is set so that the black matrix covers the above described electrical field controlling electrode EFC, and the side SD of the width is approximately in the same location as the corresponding side SD′ of the electrical field controlling electrode EFC in the direction y in the figure.

Here, the location of the above described side SD of the black matrix BM is not strict, and the side SD of the black matrix BM may be located on the front side of the corresponding side SD′ of the above described electrical field controlling electrode EFC (on the center axis side of the gate signal line GL) or over the side SD′ on the opposite side.

The electrical field controlling electrode EFC is formed of a light blocking material, and therefore, it is possible to block light sufficiently, even in the case where there is a positional shift between the substrate SUB1 and the substrate SUB2. Accordingly, it is possible to make the width of the black matrix BM smaller.

The electric lines of force EPL in the electrical field generated between the gate signal line GL and the pixel electrode PX can be prevented from bulging out greatly by forming the above described electrical field controlling electrode EFC, and as a result, the width of the black matrix BM which covers the gate signal lines GL and the side portion (end portion) PSB of the pixel electrodes PX on the gate signal line GL side can be made much smaller than in the prior art, and accordingly, the openings in the black matrix BM (indicated by OP in the figure) can be made larger. Therefore, the substantial aperture ratio of the pixels can be increased.

Here, FIG. 6A shows that a color filter FIL is formed in the aperture portion of the above described black matrix BM.

FIG. 6B shows an example of a conventional configuration, and corresponds to FIG. 6A. In FIG. 6B, the gate signal line GL and the pixel electrode PX are oriented along the y axis in the figure, in order to make positional comparison with FIG. 6A easier.

In FIG. 6B, the configuration is not provided with an electrical field controlling electrode EFC, unlike in the present embodiment, and therefore, the electric lines of force EPL in the electrical field from the gate signal lines GL terminates only on the pixel electrodes PX, and therefore, the electric lines of force EPL are distributed so as to bulge out greatly to the substrate SUB2 side.

This distribution of electric lines of force EPL means that the electrical field does not stay only on the side portion (end portion) PSD of the pixel electrode PX on the above described gate signal line GL side, and the generated electrical field reaches the center side of the pixel electrode PX.

Therefore, the black matrix BM must be formed so as to cover the portion where the electrical field is generated, as described above, and thus, it is impossible to prevent the openings in the black matrix BM from becoming smaller (indicated by OP′ in the figure).

In addition, in order to make it possible to block light sufficiently even in the case where there is a positional shift between the substrate SUB1 and the substrate SUB2, it is necessary to make the width of the black matrix BM greater by the margin of the positional shift, and the openings OP′ in the black matrix BM become smaller by the same amount.

In the above described embodiment, as shown in FIG. 3, a number of linear electrodes in the pixel electrode PX are oriented so that the longitudinal direction of the electrodes makes a slight angle with to the direction in which the gate signal lines GL run. However, the invention is not limited to this, and a number of linear electrodes may be provided parallel to the direction in which the drain signal lines DL run (direction y in figure), for example.

In this case also, the number of linear electrodes in the pixel electrode PX are formed so as to be connected to each other at the end on the gate signal line GL side. This is because the pad portion PD of the source electrode ST in the thin film transistor TFT must be provided in the vicinity of the gate signal line GL, so that the above described number of linear electrodes are electrically connected to the pad portion PD. Thus, the above described pixel electrode PX has a side portion (end portion) PSD as shown in FIGS. 1A and 1B on the gate signal line GL side, and the present invention can be applied as it is.

Here, the liquid crystal display device according to the present invention is a transmission type liquid crystal display device, and it is desirable for a backlight to be provided on the rear side.

The above described embodiment may be used alone or combined for use, as the effects of the respective embodiments can be gained when used alone or in combination.

1. A liquid crystal display device, comprising a first substrate, a second substrate and a liquid crystal layer sandwiched between said first substrate and said second substrate, characterized in that
said first substrate has a number of gate signal lines, drain signal lines which cross said number of gate signal lines, and a number of pixels arranged in a matrix,
each of said number of pixels has a thin film transistor, a pixel electrode and a counter electrode,
said light transmitting counter electrodes, a first insulating film, a second insulating film and said light transmitting pixel electrodes are formed on said first substrate in this order, so that an electrical field generated as a result of a difference in potential between said pixel electrodes and said counter electrodes can control said liquid crystal layer,
said thin film transistor has a gate electrode formed of part of said gate signal line, a drain electrode formed of part of said drain signal line, and a source electrode connected to said pixel electrode through a through hole created in said second insulating film,
said counter electrode has a pattern in plane form,
said pixel electrode is formed so as to have a number of linear electrodes which overlap with said counter electrode in a pattern, and
said source electrode is formed of a light blocking material, located between said first insulating film and said second insulating film, and formed so as to extend in the direction in which said gate signal lines run and overlap with 80% or more of the total length in one end portion of said pixel electrode on said gate signal line side.

2. The liquid crystal display device according to claim 1, characterized in that part of said source electrode forms an electrical field controlling electrode for reducing the rotating electrical field generated between said gate signal lines and said pixel electrodes.

3. The liquid crystal display device according to claim 2, characterized in that part of said electrical field controlling electrode in the direction in which said electrical field controlling electrode extends includes a pad portion of said source electrode for achieving electrical connection with said pixel electrode.
